(19) United States
(12) Patent Application Publication
(10) Pub. No.: US 2025/0369663 A1
(43) Pub. Date: Dec. 4, 2025

(54) FRAME ASSEMBLIES AND CONTROLS OF AN EVAPORATIVE COOLING SYSTEM AND METHOD

(71) Applicant: Tyco Fire & Security GmbH, Neuhausen am Rheinfall (CH)

(72) Inventors: Mohammad Ashrafuzzaman, Seattle, AZ (US); Paul Andrew White, Calgary (CA)

(21) Appl. No.: 19/224,342

(22) Filed: May 30, 2025

Related U.S. Application Data
(60) Provisional application No. 63/654,793, filed on May 31, 2024.

(51) Int. Cl. F25B 39/02; B23P 15/26

(52) U.S. Cl. CPC F25B 39/02; B23P 15/26

(57) ABSTRACT

An evaporative cooling system includes a frame having openings arranged in a column. The evaporative cooling system also includes evaporative cooling units coupled to the frame. Each evaporative cooling unit includes an open end configured to receive an airflow and aligned with a respective opening of the openings in the frame, a closed end opposing the open end and configured to block the airflow, and a body extending between the open end and the closed end. The body is formed at least in part by a sheet containing microporous hollow fibers. Each microporous hollow fiber is configured to receive a flow of a liquid establishing a heat exchange relationship between the liquid and the airflow. The sheet is configured to permit passage of the airflow between an interior defined by the body and an external space.

### CROSS-REFERENCE TO RELATED APPLICATIONS

This application claims priority from and the benefit of U.S. Provisional Application Ser. No. 63/654,793, entitled “FRAME ASSEMBLIES AND CONTROLS OF AN EVAPORATIVE COOLING SYSTEM AND METHOD,” filed May 31, 2024, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

This application relates generally to heating, ventilating, air conditioning, and/or refrigeration (HVAC&R) systems, and more specifically, to evaporative cooling systems and methods with improved efficiency, cost, and installation features.

Evaporative cooling systems provide a means for cooling by way of liquid (e.g., water) evaporation. For example, as a fluid (e.g., liquid fluid, such as water) is exposed to a warm airflow, a heat exchange relationship therebetween causes the fluid (or a portion thereof) to change from a liquid state to a vapor state, causing heat (e.g., latent heat) to be absorbed by the fluid. Additionally or alternatively, the vapor produced by the heat exchange relationship may humidify the airflow prior to delivery of the airflow to a conditioned space.

Traditional evaporative cooling systems may be employed in residential, commercial, industrial, and/or data center contexts. While traditional evaporative cooling systems provide some advantages over certain other types of cooling, certain traditional evaporative cooling systems may be expensive and time-consuming to manufacture, install, maintain, and/or repair. Additionally or alternatively, certain traditional evaporative cooling systems may be inefficient and/or susceptible to liquid or water carryover, parasitic loss, bacterial growth, scaling and/or mineral deposits, and other possible drawbacks. Accordingly, it is now recognized that improved evaporative cooling systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an evaporative cooling system includes a frame having openings arranged in a column. The evaporative cooling system also includes evaporative cooling units coupled to the frame. Each evaporative cooling unit includes an open end configured to receive an airflow and aligned with a respective opening of the openings in the frame, a closed end opposing the open end and configured to block the airflow, and a body extending between the open end and the closed end. The body is formed at least in part by a sheet containing microporous hollow fibers. Each microporous hollow fiber is configured to receive a flow of a liquid establishing a heat exchange relationship between the liquid and the airflow. The sheet is configured to permit passage of the airflow between an interior defined by the body and an external space.

In another embodiment, an evaporative cooling system includes frames defining openings, where adjacent frames are coupled together to form a sealed seam therebetween. The evaporative cooling system also includes evaporative cooling units coupled to the frames, aligned with the openings defined by the frames, and configured to establish a heat exchange relationship between a liquid and an airflow. The evaporative cooling system also includes at least one valve and a controller. The controller is configured to control the at least one valve to cause all of the evaporative cooling units to receive the liquid in a first operating mode, and to cause only a subset of the evaporative cooling units to receive the liquid in a second operating mode.

In still another embodiment, a method of installing evaporative cooling units in an evaporative cooling system includes coupling a first frame having first openings arranged in a first column to a second frame having second openings arranged in a second column such that a seam between the first frame and the second frame is sealed. The method also includes coupling first evaporative cooling units to the first frame such that each first evaporative cooling unit of the first evaporative cooling units is aligned with a respective first opening of the first openings in the first frame. The method also includes coupling second evaporative cooling units to the second frame such that each second evaporative cooling unit of the second evaporative cooling units is aligned with a respective second opening of the second openings in the second frame.

### BRIEF DESCRIPTION OF THE DRAWINGS

Various aspects of this disclosure may be better understood upon reading the following detailed description and upon reference to the drawings in which:

FIG. 1 is a block diagram of an evaporative cooling system including a plumbing assembly, a controller, and frames, each frame defining openings arranged in a column and configured to be aligned with evaporative cooling units of the evaporative cooling system, in accordance with an aspect of the present disclosure;

FIG. 2 is a perspective view of an evaporative cooling unit employed in an evaporative cooling system, such as the evaporative cooling system of FIG. 1, including an open end through which an airflow enters an interior of the evaporative cooling unit, in accordance with an aspect of the present disclosure;

FIG. 3 is a perspective view of an evaporative cooling unit employed in an evaporative cooling system, such as the evaporative cooling system of FIG. 1, including an open end through which an airflow exits an interior of the evaporative cooling unit, in accordance with an aspect of the present disclosure;

FIG. 4 is a magnified cross-sectional view of a microporous hollow fiber employed in an evaporative cooling unit of an evaporative cooling system, such as the evaporative cooling system of FIG. 1, in accordance with an aspect of the present disclosure;

FIG. 5 is a perspective view of an evaporative cooling system, such as the evaporative cooling system of FIG. 1, in accordance with an aspect of the present disclosure;

FIG. 6 is a cross-sectional side view of the evaporative cooling system of FIG. 5, in accordance with an aspect of the present disclosure;

FIG. 7 is a perspective view of a portion of an evaporative cooling system, such as the evaporative cooling system of FIG. 1, illustrating open ends of evaporative cooling units coupled to frames of the evaporative cooling system, in accordance with an aspect of the present disclosure;

FIG. 8 is a perspective view of a portion of an evaporative cooling system, such as the evaporative cooling system of FIG. 1, illustrating closed ends of evaporative cooling units coupled to frames of the evaporative cooling system, in accordance with an aspect of the present disclosure;

FIG. 9 is a schematic illustration of an evaporative cooling system, such as the evaporative cooling system of FIG. 1, including various flow control features included in the plumbing assembly, in accordance with an aspect of the present disclosure;

FIG. 10 is a perspective view of a frame employed in an evaporative cooling system, such as the evaporative cooling system of FIG. 1, in accordance with an aspect of the present disclosure;

FIG. 11 is a front view of the frame of FIG. 10, in accordance with an aspect of the present disclosure;

FIG. 12 is a front view of a portion of the frame of FIG. 11, taken along line 12-12 in FIG. 11, in accordance with an aspect of the present disclosure;

FIG. 13 is a cross-sectional view of a fastener configured to couple an evaporative cooling unit of an evaporative cooling system to a frame of the evaporative cooling system, in accordance with an aspect of the present disclosure; and

FIG. 14 is a process flow diagram illustrating a method of installing evaporative cooling units in an evaporative cooling system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to a heating, ventilating, air conditioning, and/or refrigeration (HVAC&R) system, such as an evaporative cooling system. The evaporative cooling system includes various features configured to improve evaporative cooling effectiveness and efficiency (e.g., by reducing parasitic loss), improve structural integrity of evaporative cooling systems, reduce a cost of installing and/or operating evaporative cooling systems, improve installation time and reduce labor costs associated with evaporative cooling systems, and the like.

An embodiment of the evaporative cooling system includes a frame defining openings therein. In some embodiments, the evaporative cooling system includes at least two frames defining openings therein. Each frame may include any number of openings, such as ten openings, arranged in a column. The evaporative cooling system includes a number of evaporative cooling units coupled to the frames and aligned with the openings defined within the frames. For example, a first frame may define ten first openings arranged in a first column aligned with ten first evaporative cooling units coupled to the first frame, a second frame may define ten second openings arranged in a second column aligned with ten second evaporative cooling units coupled to the second frame, the second frame may be positioned adjacent to the first frame, and edges of the first frame and the second frame may be coupled together to form a sealed seam. As an example, the first frame and the second frame are configured to support a weight of the ten first evaporative cooling units and the ten second evaporative cooling units. In other embodiments, the frames may support a weight of a different number of evaporative cooling units (e.g., fewer than ten or more than ten evaporative cooling members).

The first fame, the second frame, the ten first evaporative cooling units, the ten second evaporative cooling units, and other componentry in certain embodiments (e.g., additional frames and additional evaporative cooling units) may be referred to as an evaporative cooling assembly. The sealed seam between the first frame and the second frame may be configured to block an airflow approaching the evaporative cooling assembly from bypassing the ten first evaporative cooling units and the ten second evaporative cooling units. It should be noted that any number of frames (e.g., two frames, three frames, four frames, five frames, six frames, seven frames, or more than seven frames) and any number of evaporative cooling units per frame (e.g., two evaporative cooling units, three evaporative cooling units, four evaporative cooling units, five evaporative cooling units, six evaporative cooling units, seven evaporative cooling units, eight evaporative cooling units, nine evaporative cooling units, ten evaporative cooling units, or more than ten evaporative cooling units) may be employed in the evaporative cooling assembly.

In some embodiments, a plumbing assembly distributes a liquid (e.g., water) to the various evaporative cooling units in parallel with one another. For example, the first evaporative cooling units corresponding to the first frame may receive the liquid (e.g., water) in parallel with the second evaporative cooling units corresponding to the second frame. Likewise, each evaporative cooling unit corresponding to a particular frame may receive the liquid (e.g., water) in parallel with the other evaporative cooling units corresponding to the particular frame. For example, one of the first evaporative cooling units corresponding to the first frame may receive the liquid (e.g., water) in parallel with one or more of the other first evaporative cooling units corresponding to the first frame. Further, a controller may be configured to control one or more components (e.g., one or more valves, such as one or more on/off valves, one or more control valves, etc.) to selectively distribute the liquid (e.g., water) to all of the evaporative cooling units in the evaporative cooling system or to a subset of the evaporative cooling units of the evaporative cooling system. In some embodiments, such selective distribution of the liquid (e.g., water) is based on one or more ambient or operating conditions, such as a cooling load or demand (e.g., corresponding to a data center, a conditioned space, etc.), a temperature, a thermostat setpoint, or some other ambient or operating condition. In some embodiments, the controller may also control one or more bypass dampers to selectively enable or disable an airflow through a bypass section around the evaporative cooling assembly.

Each evaporative cooling unit may include an open end configured to enable the airflow to pass therethrough, a closed end opposing the open end and configured to block the airflow from passing therethrough, and a body extending between the open end and the closed end. The body may be formed by a sheet containing microporous hollow fibers therein, where each microporous hollow fiber is configured to receive the liquid (e.g., water) by way of the plumbing assembly. The microporous hollow fibers are configured to block the liquid (e.g., water) from exiting the evaporative cooling unit into the airflow. However, the microporous hollow fibers may be configured to enable vapor, generated via a heat exchange relationship between the liquid (e.g., water) and the airflow, to exit the evaporative cooling unit into the airflow. In this way, presently disclosed embodiments block liquid droplets from being entrained in the airflow but enable a humidification of the airflow.

In general, presently disclosed systems and methods are configured to improve evaporative cooling effectiveness and efficiency (e.g., by reducing parasitic loss), improve structural integrity of evaporative cooling systems, reduce a cost of installing and/or operating evaporative cooling systems, improve installation time and reduce labor costs associated with evaporative cooling systems, and the like. These and other aspects of the present disclosure are described in greater detail below with reference to the drawings.

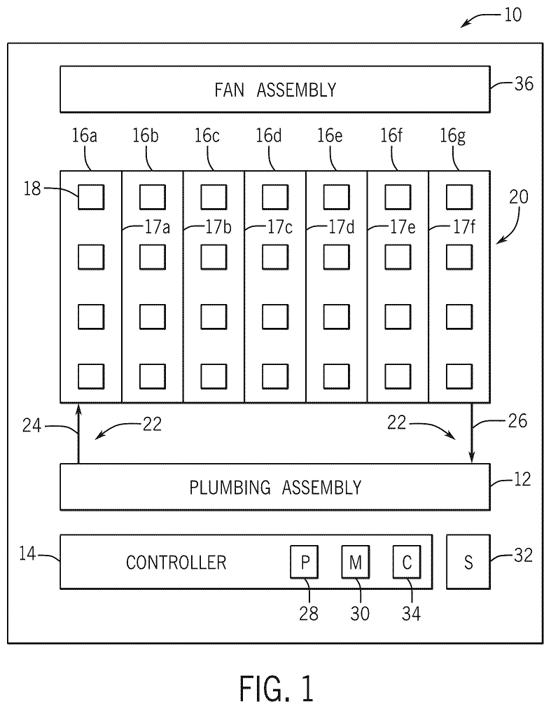

FIG. 1 is a block diagram of an embodiment of an evaporative cooling system 10 including a plumbing assembly 12, a controller 14, and various frames 16 (e.g., 16a, 16b, 16c, 16d, 16e, 16f, 16g), where each of the frames 16 defines openings arranged in a column and configured to be aligned with evaporative cooling units 18 coupled to the frames 16. The frames 16 and the evaporative cooling units 18 may be referred to as an evaporative cooling assembly 20 in accordance with the present disclosure.

As shown, and as described in greater detail with reference to later drawings, adjacent frames 16 may be coupled together to form sealed seams 17 therebetween and block an airflow from passing therethrough between adjacent frames 16. For example, the first frame 16a and the second frame 16b may be coupled to form a first sealed seam 17a, the second frame 16b and the third frame 16c may be coupled to form a second sealed seam 17b, the third frame 16c and the fourth frame 16d may be coupled to form a third sealed seam 17c, the fourth frame 16d and the fifth frame 16e may be coupled to form a fourth sealed seam 17d, the fifth frame 16e and the sixth frame 16f may be coupled to form a fifth sealed seam 17e, and the sixth frame 16f and the seventh frame 16 g may be coupled to form a sixth sealed seam 17f. In this way, the evaporative cooling assembly 20 is configured such that the airflow is forced through the evaporative cooling units 18 and does not bypass the evaporative cooling units 18 via gaps between adjacent frames 16, as no such gaps exist in the illustrated embodiment. It should be noted that any number of the frames 16 and any number of the evaporative cooling units 18 per frame (e.g., ten evaporative cooling units 18 per frame 16) may be employed.

The plumbing assembly 12 is configured to distribute a liquid (e.g., water) to the evaporative cooling units 18 via a liquid (e.g., water) circuit 22, which includes an inlet line 24 to the evaporative cooling assembly 20 and an outlet line 26 from the evaporative cooling assembly 20. In some embodiments, the evaporative cooling units 18 receive the liquid (e.g., water) in parallel with one another. For example, the evaporative cooling units 18 corresponding to the first frame 16a and the evaporative cooling units 18 corresponding to the second frame 16b may be disposed in parallel relative to a flow of the liquid through the liquid circuit 22. Further, the evaporative cooling units 18 of a particular frame 16, such as the first frame 16a, may be disposed in parallel with one another relative to a flow of the liquid in the liquid circuit 22.

The controller 14 is configured to control aspects of the plumbing assembly 12, such as one or more valves, pumps, and the like, to regulate the flow of the liquid through the liquid circuit 22. For example, the controller 14 includes processing circuitry 28 and memory circuitry 30. The memory circuitry 30 may include a volatile memory, such as random access memory (RAM), and/or a nonvolatile memory (ROM). The memory circuitry 30 may store a variety of information and may be used for various purposes. For example, the memory circuitry 30 may store processor-executable instructions, such as instructions for controlling aspects of the plumbing assembly 12, such as one or more valves, pumps, and the like, to regulate the flow of the liquid through the liquid circuit 22. The memory circuitry 30 may also include flash memory, or any suitable optical, magnetic, or solid-state storage medium, or a combination thereof.

In some embodiments, the controller 14 receives sensor feedback from one or more sensors 32 indicative of one or more ambient or operating conditions, such as a temperature (e.g., outdoor temperature, condition space temperature, load temperature, wet bulb temperature, dry bulb temperature, etc.), a cooling load, a cooling demand, a pressure, a thermostat setpoint, and/or some other operating or ambient condition(s), and controls aspects of the plumbing assembly 12 based on the sensor feedback. Indeed, the controller 14 may control one or more valves of the plumbing assembly 12 to selectively enable or disable a flow of the liquid to certain of the evaporative cooling units 18 in the evaporative cooling assembly 20. As an example, the controller 14 may control, in response to determining a desirable operating mode based on the sensor feedback, one or more valves of the plumbing assembly 12 to enable the evaporative cooling units 18 corresponding to the first, second, and third frames 16a, 16b, 16c to receive the liquid and to disable the evaporative cooling units 18 corresponding to the fourth, fifth, sixth, and seventh frames 16d, 16e, 16f, 16g from receiving the liquid. Additionally or alternatively, the controller 14 may control (e.g., based on the sensor feedback) one or more pumps of the plumbing assembly 12 disposed on the liquid circuit 22, or some other liquid flow regulating device, to control a flow rate of the liquid through the liquid circuit 22 and/or to the evaporative cooling assembly 20. As described in detail with reference to later drawings, the controller 14 may control (e.g., based on the sensor feedback) one or more bypass dampers configured to enable an airflow to bypass the evaporative cooling assembly 20 (e.g., around sides of the evaporative cooling assembly 20).

Additionally or alternatively, the controller 14 may receive a manual input and control various aspects of the plumbing assembly 12 based on the manual input, such as any and all of the control aspects described above. It should be noted that the controller 14 may be communicatively coupled to various aspects of the evaporative cooling system 10, such as various aspects of the plumbing assembly 12 controlled by the controller 14, via a wired or wireless connection. In some embodiments, the controller 14 employs communications circuitry 34 (e.g., a transmitter, a receiver, a transceiver) to transmit and/or receive signals employed in various controls of the present disclosure, such as those described above.

For brevity, the controller 14, the processing circuitry 28, the memory circuitry 30, and the communications circuitry 34 are each respectively illustrated as a single block in FIG. 1. However, it should be understood that the controller 14 may be employed to herein refer to multiple controllers, the processing circuitry 28 may be employed herein to refer to multiple processors, the memory circuitry 30 may be employed herein to refer to multiple memories, and the communications circuitry 34 may be employed herein to refer to multiple communication componentry.

The evaporative cooling system 10 also includes a fan assembly 36 (e.g., one or more fans) configured to generate an airflow over the evaporative cooling assembly 20. In this way, the evaporative cooling system 10 establishes heat exchange relationships between the airflow passing over the evaporative cooling units 18 of the evaporative cooling assembly 20 and the liquid (e.g., water) passing through the evaporative cooling units 18. In some embodiments, the fan assembly 36 is controlled by the controller 14 based on sensor feedback and/or manual inputs, as previously described. As described in greater detail below, the evaporative cooling units 18 may include microporous hollow fibers configured to receive the liquid (e.g., water), establish a heat exchange relationship between the liquid (e.g., water) and the airflow, contain the liquid (e.g., water) therein, and enable vapor generated by the heat exchange relationship to pass through pores (e.g., micropores) in the microporous hollow fibers and into the airflow. In this way, heat (e.g., latent heat) is absorbed and the airflow is cooled, without causing undesirable liquid (e.g., water) carryover into the airflow. Additionally or alternatively, the vapor produced by the heat exchange relationship may humidify the airflow in certain embodiments prior to delivery of the airflow to a conditioned space, such as a data center. These and other aspects of the present disclosure are described in greater detail below.

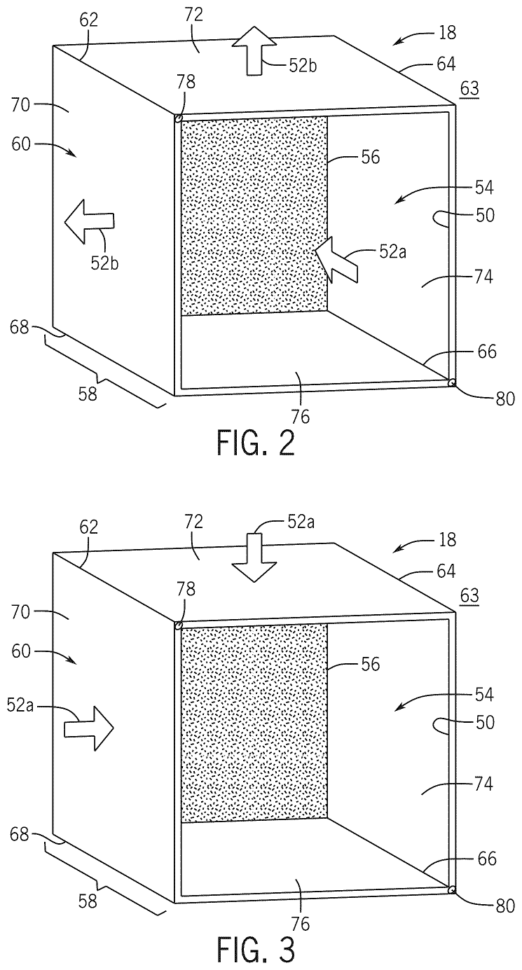

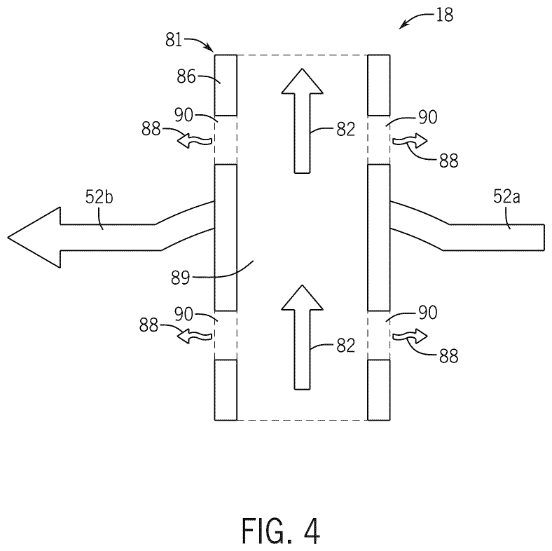

FIGS. 2 and 3 are perspective views of embodiments of the evaporative cooling unit 18 employed in, for example, the evaporative cooling system 10 of FIG. 1. The evaporative cooling units 18 in FIGS. 2 and 3 may be substantially similar, except that they are positioned differently relative to an airflow being conditioned by the evaporative cooling unit. For example, focusing first on FIG. 2, the evaporative cooling unit 18 includes an open end 50 through which a warm airflow 52a enters an interior 54 of the evaporative cooling unit 18. The evaporative cooling unit 18 also includes a closed end 56 opposing the open end 50, where the closed end 56 is not permeable to the warm airflow 52a. The evaporative cooling unit 18 also includes a body 58 extending between the open end 50 and the closed end 56 (e.g., from the open end 50 to the closed end 56). In some embodiments, the body 58 includes a sheet 60 (e.g., flexible sheet, fabric sheet, etc.) containing a number of microporous hollow fibers contained (e.g., embedded, woven, etc.) therein. For example, the sheet 60 may be wound about anchors (not shown) disposed at (or forming) edges 62, 64, 66, 68 of the body 58 of the evaporative cooling unit 18. In some embodiments, the sheet 60 is wound about the anchors multiple times, such that multiple layers of the sheet 60 (and corresponding microporous hollow fibers) are employed at each side 70, 72, 74, 76 of the body 58 of the evaporative cooling unit 18. The sheet 60 may be arranged (e.g., via the anchors or some other mechanism) to include a generally rectangular, rhombus, or squircle cross-sectional shape.

In general, the sheet 60 (and/or layers thereof) may be permeable to the warm airflow 52a. That is, the warm airflow 52a in FIG. 2 may pass from the interior 54 of the evaporative cooling unit 18, through the sheet 60, and into an external space 63 as a cooled airflow 52b. Due to the illustrated perspective, the cooled airflow 52b is only illustrated as passing through two of the sides 70, 72 of the body 58, although it should be understood that the cooled airflow 52b also passes through the other two of the sides 74, 76 of the body 58. The warm airflow 52a is cooled by a liquid (e.g., water) in the microporous hollow fibers contained in the sheet 60 as the warm airflow 52a passes through the sheet 60. For example, the evaporative cooling unit 18 includes a liquid (e.g., water) inlet 78 (e.g., inlet header, inlet tube, etc.), which passes the liquid (e.g., water) to the microporous hollow fibers contained in the sheet 60 and coupled to the liquid inlet 78. The evaporative cooling unit 18 also includes a liquid (e.g., water) outlet 80 (e.g., outlet header, outlet tube, etc.), which receives the liquid (e.g., water) from the microporous hollow fibers contained in the sheet 60 and coupled to the liquid outlet 80. As previously described, a portion of the liquid within the microporous hollow fibers may evaporative into vapor, and pores of the microporous hollow fibers may be configured (e.g., sized, shaped, etc.) to enable the vapor to pass into the warm airflow 52a as it is cooled and becomes the cooled airflow 52b. However, the pores of the microporous hollow fibers may be configured (e.g., sized, shaped, etc.) to block the liquid (i.e., unevaporated portion of the liquid) from escaping the microporous hollow fibers, thereby blocking undesirable water carryover. FIG. 3 is substantially similar to FIG. 2, except that in FIG. 3, the evaporative cooling unit 18 is configured to receive the warm airflow 52a through the sides 70, 72, 74, 76 of the body 58 and into the interior 54, such that the cooled airflow 52b exits the interior 54 through the open end 50 of the evaporative cooling unit 18.

FIG. 4 is a magnified cross-sectional view of an embodiment of a microporous hollow fiber 81 employed in an evaporative cooling unit of an evaporative cooling system, such as the evaporative cooling unit 18 of the evaporative cooling system 10 of FIG. 1. As shown, a flow of a liquid 82 (e.g., water) moves through a microporous hollow fiber cavity 84 (or liquid flow path) and is contained within the volume enclosed by one or more walls 86 of the microporous hollow fiber 81. The warm airflow 52a is directed toward the microporous hollow fiber 81. When ambient conditions permit, liquid water vaporizes into the airstream (exterior to the microporous hollow fiber walls 86) by undergoing a phase change. Water vapor 88 exits the microporous hollow fiber cavity 84 (or liquid flow path) through a plurality of pores 90 and comes into direct contact with the ambient air, such as the cooled airflow 52b. The water vapor 88 mixes with the ambient air and adiabatically cools and/or humidifies the airflow 52b. The microporous hollow fiber 81 in FIG. 4 may be one of many contained within the sheet 60 of the evaporative cooling unit(s) 18 in FIGS. 1-3.

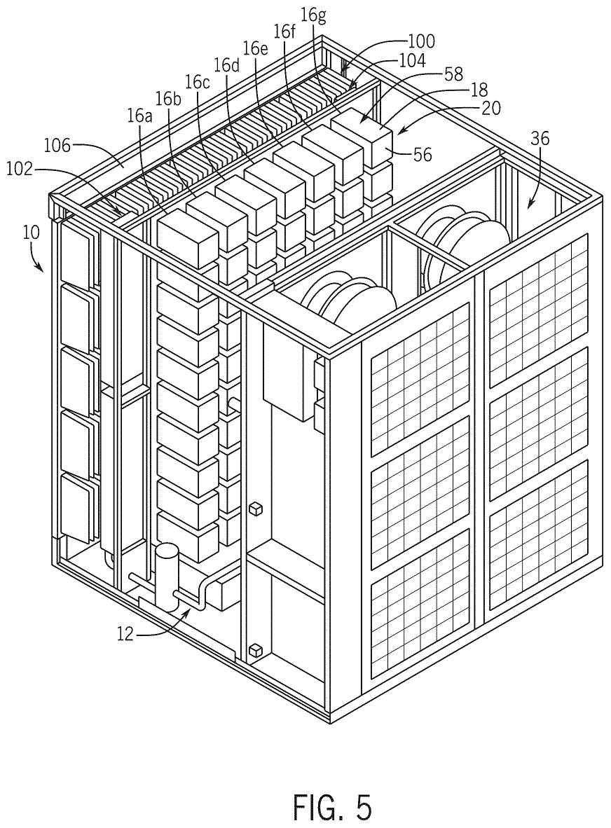

FIG. 5 is a perspective view of an embodiment of an evaporative cooling system, such as the evaporative cooling system 10 of FIG. 1. In the illustrated embodiment, the evaporative cooling system 10 includes the evaporative cooling assembly 20 having a number of the frames 16 (e.g., first frame 16a, second frame 16b, third frame 16c, fourth frame 16d, fifth frame 16e, sixth frame 16f, and seventh frame 16g), each of which corresponds to a number of the evaporative cooling units 18, such as ten instances of the evaporative cooling unit 18 per frame 16. The closed ends 56 and the bodies 58 of the evaporative cooling units 18 are shown from the illustrated perspective. Thus, open ends 50 (not shown in the illustrated perspective) of the evaporative cooling units 18 may face a filter assembly 100 of the evaporative cooling system 10.

As shown, the filter assembly 100 is disposed upstream of the evaporative cooling units 18 relative to a direction of an airflow through the evaporative cooling assembly 20. The fan assembly 36, disposed downstream of the filter assembly 100 and the evaporative cooling assembly 20 relative to the direction of the airflow through the evaporative cooling assembly 20 in the illustrated embodiment, is configured to draw the airflow through the filter assembly 100 and the evaporative cooling assembly 20. The filter assembly 100 is configured to filter the airflow (e.g., by removing contaminants, particulates, etc. from the airflow) prior to delivery of the airflow to the evaporative cooling assembly 20. In this way, the evaporative cooling units 18 of the evaporative cooling assembly 20 are less likely to be saturated with (and/or better protected from) contaminants, particulates, etc. The plumbing assembly 12, described in greater detail with reference to later drawings, is configured to distribute the liquid (e.g., water) to the evaporative cooling units 18 of the evaporative cooling assembly 20 of the evaporative cooling system 10 (e.g., where the evaporative cooling units 18 are in parallel with one another relative to the flow of the liquid, such as water).

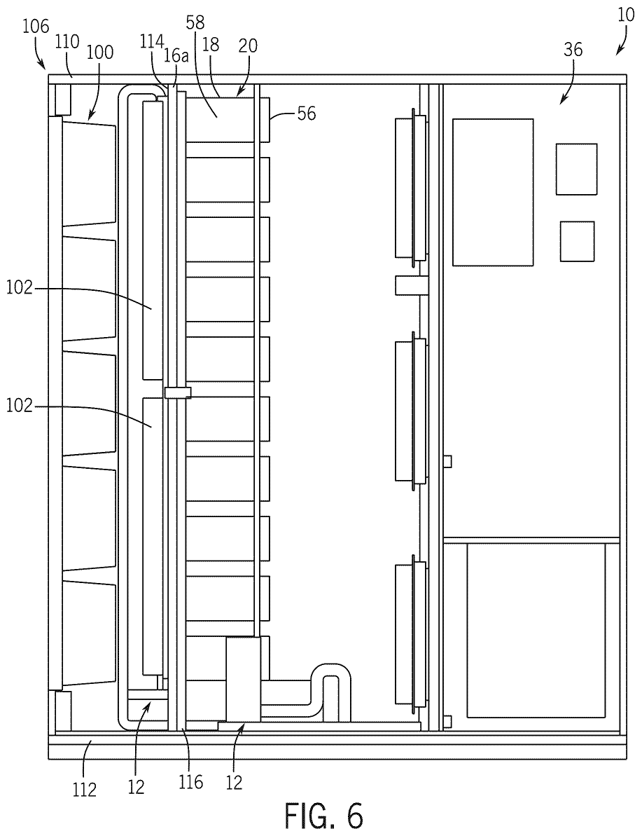

As shown, the evaporative cooling assembly 20 may be lined with a first bypass damper 102 on a first side of the evaporative cooling assembly 20 and a second bypass damper 104 on a second side of the evaporative cooling assembly 20. While the airflow may be always blocked from bypassing the evaporative cooling assembly 20 between adjacent frames 16 of the evaporative cooling assembly 20, such as between the first frame 16a and the second frame 16b, the first bypass damper 102 and/or the second bypass damper 104 may be selectively controlled to enable the airflow (or a portion thereof) to bypass the evaporative cooling assembly 20 around one or more sides of the evaporative cooling assembly 20. That is, the first bypass damper 102 may be selectively controlled between a first open position and a first closed position, and the second bypass damper 104 may be selectively controlled between a second open position and a second closed position. In some embodiments, the first bypass damper 102 and/or the second bypass damper 104 are controlled (e.g., actuated) by a controller, such as the controller 14 in FIG. 1, based on a manual input or feedback (e.g., sensor feedback) indicative of an ambient or operating condition, as previously described. The above-described features of the evaporative cooling system 10 in FIG. 5 may be disposed in an evaporative cooling system housing 106, described in greater detail below with reference to FIG. 6.

The evaporative cooling assembly 20 in the illustrated embodiment enables particularly beneficial technical effects in the context of retrofit assemblies and/or during installation, maintenance, and/or repair procedures. For example, the frames 16 and the evaporative cooling units 18 of the evaporative cooling assembly 20 are self-contained in a single block within a cavity of the evaporative cooling system housing 106. If one column (e.g., the first frame 16a and corresponding evaporative cooling units 18) requires repair, maintenance, or replacement, said column (e.g., the first frame 16a and corresponding evaporative cooling units 18) can be easily removed and repaired or replaced. Additionally or alternatively, if a single evaporative cooling unit 18 (such as the upper most evaporative cooling unit 18 corresponding to the seventh frame 16g) requires repair, maintenance, or replacement, the single evaporative cooling unit 18 can be easily removed and repaired or replaced. Certain aspects of the present disclosure, such as plumbing schemes described at length above and below, enable continued operation of the evaporative cooling system 10 even when one or more of the evaporative cooling units 18 (including an entire column corresponding to a particular one of the frames 16, such as the first frame 16a) is off-line (e.g., removed for repair and/or replacement).

FIG. 6 is a cross-sectional side view of an embodiment of the evaporative cooling system 10 of FIG. 5. Only the first frame 16a is visible from the illustrated perspective, but it should be understood that characterizations of the first frame 16a with respect to FIG. 6 below are applicable to all of the frames 16 in the evaporative cooling assembly 20. In the illustrated embodiment, the first frame 16a is coupled to a first wall 110 (e.g., ceiling) of the evaporative cooling system housing 106 and to a second wall 112 (e.g., floor) of the evaporative cooling system housing 106, thereby sealing a first seam 114 between the first frame 16a and the first wall 110 (e.g., ceiling) and a second seam 116 between the first frame 16a and the second wall 112 (e.g., floor). In this way, the airflow is forced into the evaporative cooling units 18 at least when the first bypass damper 102 and the second bypass damper 104 (not shown in the illustrated perspective, but shown in FIG. 5) are in closed positions. Indeed, the frames 16 are coupled together to block or preclude spaces between the frames 16 of the evaporative cooling assembly 20, as previously described, and the frames 16 are coupled to the first wall 110 (e.g., ceiling) and the second wall 112 (e.g., floor) of the evaporative cooling system housing 106 to block or preclude spaces between the frames 16 and the first wall 110 (e.g., ceiling) and the second wall 112 (e.g., floor).

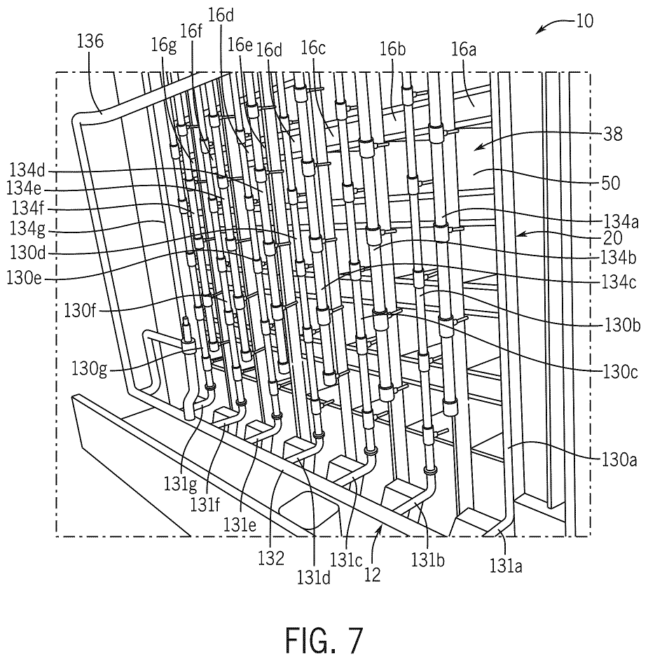

FIG. 7 is a perspective view of a portion of an embodiment of an evaporative cooling system, such as the evaporative cooling system 10 of FIG. 1, illustrating the open ends 50 of evaporative cooling units 18 coupled to frames 16 (e.g., first frame 16a, second frame 16b, third frame 16c, fourth frame 16d, fifth frame 16e, sixth frame 16f, and seventh frame 16g) of the evaporative cooling system 10. As shown, aspects of the plumbing assembly 12 are configured to distribute the liquid (e.g., water) to all of the evaporative cooling units 18 in the evaporative cooling assembly 20. For example, inlet conduits 130 (e.g., first inlet conduit 130a, second inlet conduit 130b, third inlet conduit 130c, fourth inlet conduit 130d, fifth inlet conduit 130e, and sixth inlet conduit 130f, and seventh inlet conduit 130g) corresponding to the evaporative cooling units 18 of each frame 16 (e.g., first frame 16a, second frame 16b, third frame 16c, fourth frame 16d, fifth frame 16e, sixth frame 16f, and seventh frame 16g, respectively) are coupled to a liquid inlet header 132 (e.g., liquid inlet manifold) configured to distribute the liquid to the evaporative cooling units 18 to the inlet conduits 130 in parallel. In some embodiments, on/off valves 131 (e.g., first on/off valve 131a, second on/off valve 131b, third on/off valve 131c, fourth on/off valve 131d, fifth on/off valve 131e, sixth on/off valve 131f, and seventh on/off valve 131g) are controllable to open positions enabling the flow of liquid into the evaporative cooling units 18 corresponding to each frame 16 (e.g., first frame 16a, second frame 16b, third frame 16c, fourth frame 16d, fifth frame 16e, sixth frame 16f, and seventh frame 16g, respectively) and closed positions disabling the flow of liquid into the evaporative cooling units 18 corresponding to each frame 16 (e.g., first frame 16a, second frame 16b, third frame 16c, fourth frame 16d, fifth frame 16e, sixth frame 16f, and seventh frame 16g, respectively).

Any level of controls granularity is possible in accordance with the present disclosure. In one embodiment, the on/off valves 131 are controlled according to multiple stages, such as a first stage in which the liquid (e.g., water) is received by all of the evaporative cooling units 18, a second stage in which the liquid is received only by the evaporative cooling units 18 corresponding to two of the frames 16 (e.g., the first frame 16a and the second frame 16b, the first frame 16a and the seventh frame 16g, the third frame 16c and the fourth frame 16d, or some other combination of two of the frames 16), and a third stage in which the liquid is received only by the evaporative cooling units 18 corresponding to four of the frames 16 (e.g., the first frame 16a, the second frame 16b, the sixth frame 16f, and the seventh frame 16g, or some other combination of four of the frames 16). Other control schemes are also possible. In general, the flow of the liquid is selectively controllable to subsets of the evaporative cooling units 18 based, for example, on ambient and/or operating conditions, such as a cooling demand or cooling load. Further, outlet conduits 134 (e.g., first outlet conduit 134a, second outlet conduit 134b, third outlet conduit 134c, fourth outlet conduit 134d, fifth outlet conduit 134e, and sixth outlet conduit 134f, and seventh outlet conduit 134g) are coupled to a liquid outlet header 136 (e.g., liquid outlet manifold) configured to receive the liquid from the evaporative cooling units 18 in parallel. Additional details regarding the plumbing assembly 12 will be described in detail with reference to later drawings.

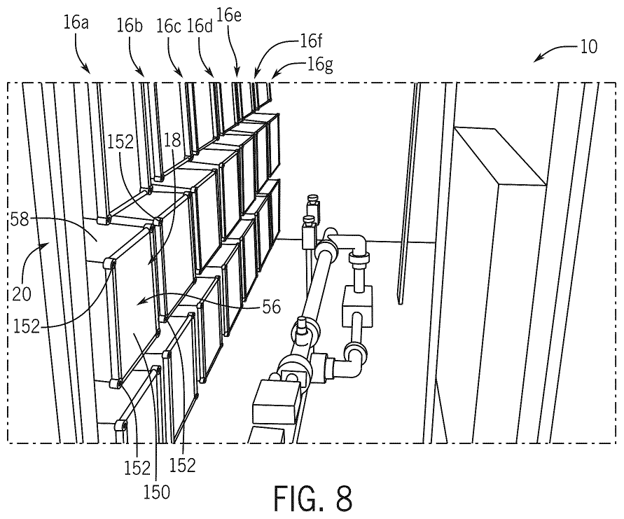

FIG. 8 is a perspective view of a portion of an embodiment of an evaporative cooling system, such as the evaporative cooling system 10 of FIG. 1, illustrating the closed ends 56 of the evaporative cooling units 18 coupled to the frames 16 (e.g., first frame 16a, second frame 16b, third frame 16c, fourth frame 16d, fifth frame 16e, sixth frame 16f, and seventh frame 16g) of the evaporative cooling system 10. As shown, each evaporative cooling unit 18 includes a plate 150 coupled the body 58 of the evaporative cooling unit 18, where the plate 150 defines the closed end 56. The plate 150 may include a generally rectangular shape with circular or semi-circular corners 152. The circular or semi-circular corners 152 may be sized and shaped to receive fasteners configured to couple the plate 150 to the body 58 of the evaporative cooling unit 18. As described in greater detail with reference to later drawings, the frames 16 include openings sized and/or shaped to receive the circular or semi-circular corners 152 of the plate 150, thereby enabling the evaporative cooling units 18 to pass through the openings in the frames 16 from either direction (e.g., from in front of the frame 16 or from behind the frame 16), reducing installation time and complexity.

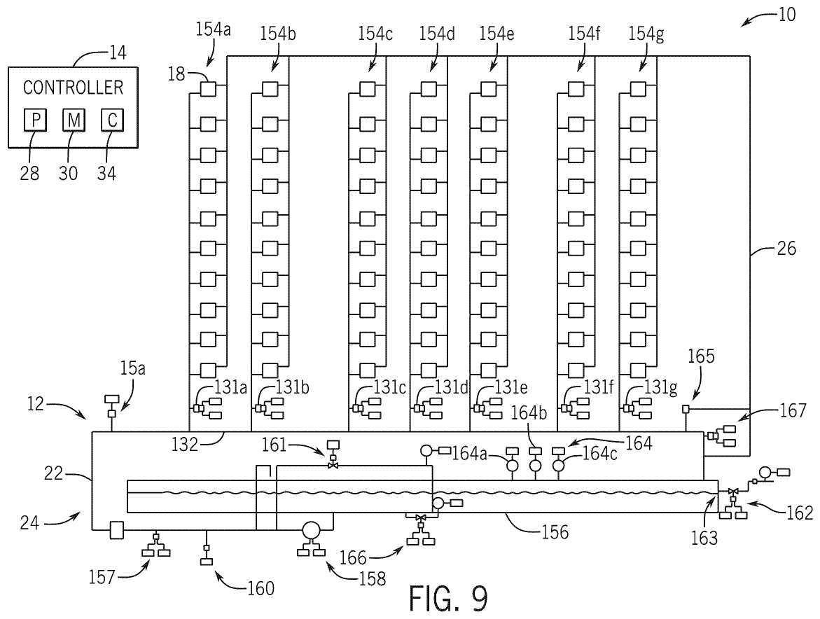

FIG. 9 is a schematic illustration of an embodiment of an evaporative cooling system, such as the evaporative cooling system 10 of FIG. 1, including various flow control features included in the plumbing assembly 12. Although the frames are not shown in the illustrated embodiment, the evaporative cooling units 18 are disposed in columns 154 (e.g., first column 154a, second column 154b, third column 154c, fourth column 154d, fifth column 154e, sixth column 154f, and seventh column 154g) corresponding to the frames previously described with respect to earlier drawings.

As shown, the plumbing assembly 12 includes a liquid reservoir 156 containing liquid distributable by the plumbing assembly 12 to the evaporative cooling units 18. As previously described, the on/off valves 131 (e.g., first on/off valve 131a, second on/off valve 131b, third on/off valve 131c, fourth on/off valve 131d, fifth on/off valve 131e, sixth on/off valve 131f, and seventh on/off valve 131g) corresponding to the columns 154 (e.g., first column 154a, second column 154b, third column 154c, fourth column 154d, fifth column 154e, sixth column 154f, and seventh column 154g) are configured to be actuated to an open position to enable the flow of liquid from the liquid reservoir 156 to the columns 154 of evaporative cooling units 18, and to a closed position to block the flow of liquid from the liquid reservoir 156 to the columns 154 of evaporative cooling units 18. As shown, the columns 154 are in parallel with one another relative to a flow of the liquid, and evaporative cooling units 18 in each column 154, such as in the first column 154a, are in parallel with one another relative to a flow of the liquid thereto. The on/off valves 131 may be selectively opened and closed, as described in greater detail below, to enable the flow of the liquid to certain instances of the columns 154 of evaporative cooling units 18 depending on an operating mode and/or staging determination. That is, in certain operating modes and/or stages, only a subset of the columns 154 of evaporative cooling units 18 receive the flow of the liquid. As one example, the controller 14 may control the first on/off valve 131a and the second on/off valve 131b during a first common time interval in a first operating mode to cause the liquid to be distributed to the first column 154a and blocked from the second column 154b, control the first on/off valve 131a and the second on/off valve 131b during a second common time interval in a second operating mode to cause the liquid to be blocked from the first column 154a and distributed to the second column 154b, and/or control the first on/off valve 131a and the second on/off valve 131b during a third common time interval in a third operating mode to cause the liquid to be distributed to the first column 154a and the second column 154b. Other controls and/or control components are also possible in accordance with the present disclosure.

For example, a control valve 157 is controllable between various settings to control a flow rate of the flow of liquid toward the header 132 coupled to the columns 154 of evaporative cooling units 18. In some embodiments, the setting of the control valve 157 is coordinated (e.g., via the controller 14) with the positions of the on/off valves 131. For example, if all of the on/off valves 131 are set to an open position such that all of the columns 154 of evaporative cooling units 18 receive the liquid, the control valve 157 may be controlled to a setting enabling a higher flow rate of the liquid (e.g., to the header 132) than if only a subset of the on/off valves 131 are set to an open position such that only a subset of the columns 154 of evaporative cooling units 18 receive the liquid. Any number of stages for enabling a flow of the liquid to any number of the columns 154 of evaporative cooling units 18 may be employed within design constraints (e.g., in the illustrated embodiment, up to seven stages). However, in some embodiments, three stages may be employed (e.g., one stage corresponding to all of the columns 154 of evaporative cooling units 18 receiving the flow of liquid, another stage corresponding to a first subset of the columns 154 of evaporative cooling units 18 receiving the flow of liquid, and another stage corresponding to a second subset of the columns 154 of evaporative cooling units 18 receiving the flow of liquid, where the second subset is larger than the first subset).

In general, a pump 158 may be employed to bias the flow of the liquid from the liquid reservoir 156 and toward the header 132. A pressure sensor 159 may be employed to monitor a pressure of the flow of liquid to (or within) the header 132 to ensure that the pressure does not exceed a threshold pressure, where componentry (e.g., the control valve 157, the pump 158, or other componentry described above and/or below, such as a pressure relief valve 165) is controlled to reduce the pressure. The pressure relief valve 165 may be actuated in response to sensor feedback from the pressure sensor 159, or the pressure relief valve 165 may be set and/or operable to automatically open in response to a pressure exceeding a threshold amount.

A conductivity probe 160 is disposed between the pump 158 and the control valve 157 in the illustrated embodiment, where the conductivity probe 160 is configured to detect a conductivity of liquid (e.g., water) in the liquid circuit 22. The plumbing assembly 12 may include various componentry controllable (e.g., based on sensor feedback from the conductivity probe 160, or based on communication with conductivity probe 160) to ensure that the conductivity in the liquid (e.g., water) in the liquid circuit 22 remains within a desirable range, or below a threshold amount, or within some other predefined relationship with a threshold amount. For example, a bleed solenoid component 161 (e.g., valve) may be actuated to enable the flow of the liquid from the pump 158 to be bled from the liquid circuit 22 to an external area. Additionally or alternatively, a makeup valve 162 may be actuated to introduce fresh liquid (e.g., water) into the liquid reservoir 156, for example, to replace the liquid bled from the liquid circuit 22 referenced above, thereby reducing the conductivity of the liquid. The makeup valve 162 may also be actuated to an open position based on interaction with a float valve 163, for example, to ensure that a level of the liquid within the liquid reservoir 156 is maintained within a desirable range. Other level sensors 164 may be employed at least in part to inform control of the pump 158 referenced above, among other possibly componentry of the plumbing assembly 12 described below.

For example, a high-level sensor 164a may be employed to ensure that the level of the liquid in the liquid reservoir 156 does not exceed a high-level threshold amount (e.g., to block the liquid from spilling out of the liquid reservoir 156, among other possible negative effects). If sensor feedback from the high-level sensor 164a indicates that the liquid level is too high, a drain valve 166 may be actuated to drain liquid (e.g., water) from the liquid reservoir 156. Further, an operating level sensor 164b may be employed to ensure the operating level of the liquid is a sufficient value or within a sufficient range to initiate operation of the pump 158. For example, operation of the pump 158 may only be initiated (e.g., started) in response to sensor feedback from the operating sensor 164b indicating a desirable operating liquid level in certain embodiments. Further still, a low-level sensor 164c may be employed to ensure that the level of the liquid in the liquid reservoir 156 does not fall below a low-level threshold amount (e.g., to ensure the pump 158 does not run dry). While the float valve 163 described above may typically operate to cause an opening of the makeup valve 162 to introduce fresh water when the liquid level within the liquid reservoir 156 is relatively low, sensor feedback from the low-level sensor 164c may be employed to shut off the pump 158 if the liquid level within the liquid reservoir 156 is relatively low (e.g., to ensure the pump 158 does not run dry). When the system 10 is not in operation (e.g., when no evaporative cooling is needed or called for), a drainer 167 (e.g., valve) may be employed to drain the liquid from various portions of the liquid circuit 22, such as from the columns 154 of evaporative cooling units 18, and/or back into the liquid reservoir 156. It should be noted that the embodiment illustrated in FIG. 9 and described above is merely exemplary, and that other control mechanisms are possible in accordance with the present disclosure.

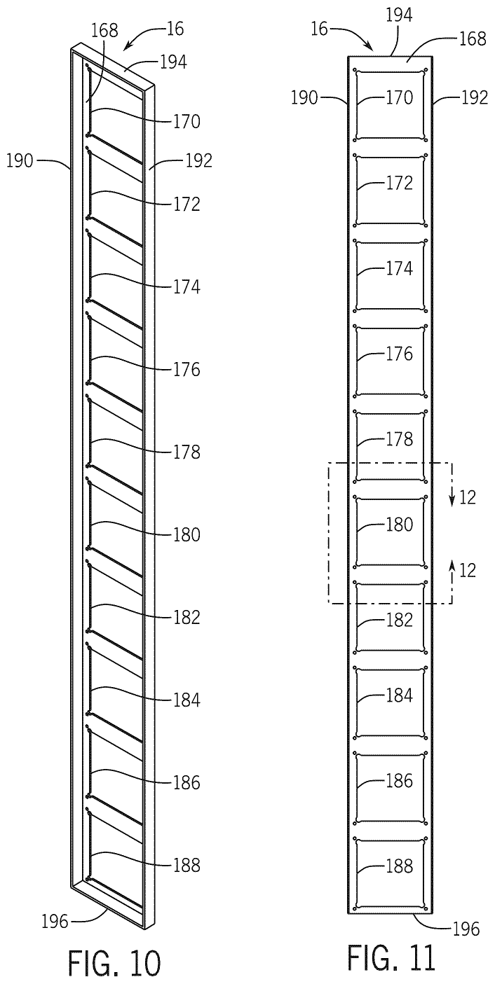

FIG. 10 is a perspective view of an embodiment of the frame 16 employed in an evaporative cooling system, such as the evaporative cooling system 10 of FIG. 1. In the illustrated embodiment, the frame 16 includes a body 168 defining openings 170, 172, 174, 176, 178, 189, 182, 184, 186, 188 configured to be aligned with respective evaporative cooling units. Further, the frame 16 includes a first edge 190 (e.g., a first flange), a second edge 192 (e.g., a second flange), a third edge 194 (e.g., a third flange), and a fourth edge 196 (e.g., a fourth flange). The first edge 190 is configured to be coupled to (e.g., via fasteners) an adjacent edge of an adjacent frame (or to a bypass damper), the second edge 192 is configured to be coupled to (e.g., via fasteners) an additional adjacent edge of an addition adjacent frame (or an additional bypass damper), the third edge 194 is configured to be coupled to (e.g., via fasteners) a first wall (e.g., a ceiling) of an evaporative cooling system housing, and the fourth edge 196 is configured to be coupled to (e.g., via fasteners) a second wall (e.g., a floor) of the evaporative cooling system housing. The frame 16 may include various characteristics (e.g., a material, such as galvanized steel in the form of sheet metal, a thickness, etc.) configured to support a weight of the evaporative cooling units coupled thereto without any additional structural support. It has been demonstrated that the frame 16 having the column arranged in the illustrated embodiment is capable of supporting the weight of up to ten of the evaporative cooling units coupled thereto. FIG. 11 is a front view of an embodiment of the frame 16 of FIG. 10 including the same or similar features illustrated in FIG. 10 and described in detail above.

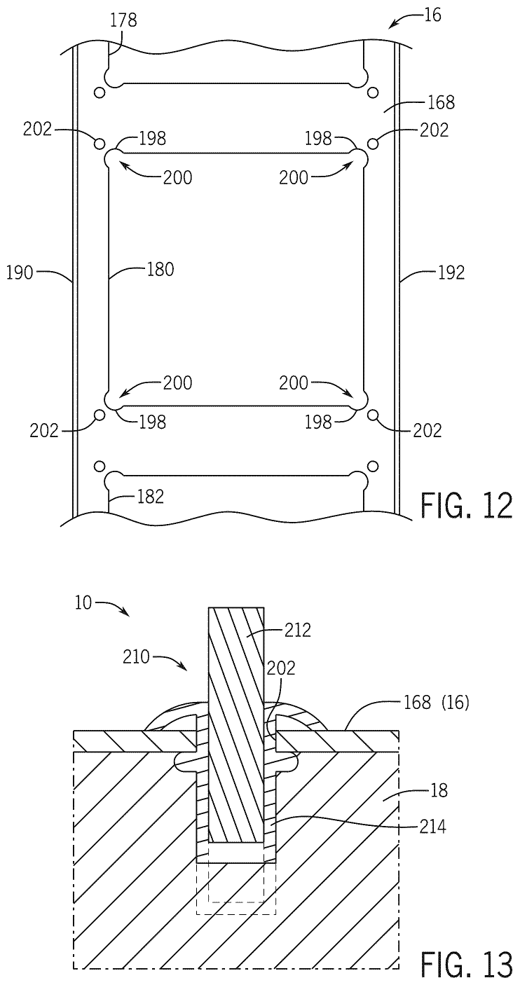

FIG. 12 is a front view of a portion of an embodiment of the frame of FIG. 11, taken along line 12-12 in FIG. 11. Focusing on the opening 180 defined by the body 168 of the frame 16 in FIG. 12, the opening 180 includes a generally rectangular shape with circular or semi-circular openings 198 disposed in corners 200 of the opening 180. The circular or semi-circular openings 198 illustrated in FIG. 12 are configured to receive the circular or semi-circular corners 152 in the plate 150 of the evaporative cooling unit 18 illustrated in FIG. 8. In this way, the evaporative cooling unit(s) 18 illustrated in earlier drawings can be received through a back or a front of the frame 16. Further, fastener holes 202 disposed adjacent to the circular or semi-circular openings 198 may be configured to enable a coupling of the frame 16 to an evaporative cooling unit, as described in detail below.

FIG. 13 is a cross-sectional view of an embodiment of a fastener 210 (e.g., fastener assembly) configured to couple the evaporative cooling unit 18 of the evaporative cooling system 10 to the frame 16 of the evaporative cooling system 10. As shown, the body 168 of the frame 16 includes the fastener hole 202. A threaded stud 212 of the fastener 210 is configured to be received by a collapsible body 214 of the fastener 210, where the collapsible body 214 is embedded in (or otherwise coupled to) the evaporative cooling unit 18. In some embodiments, the collapsible body 214 includes internal threads configured to engage threads of the threaded stud 212. As shown, the collapsible body 214 may be in a fresh or initial (e.g., elongated, non-collapsed) state prior to the threaded stud 212 being received in the collapsible body 214, and in a collapsed state when the threaded stud 212 is received by the collapsible body 214. In some embodiments, the collapsible body 214 collapses in response to the threaded stud 212 being received therein. In some embodiments, the collapsible body 214 is mechanically collapsed (e.g., via an external force) after the threaded stud 212 is inserted into the collapsible body 214.

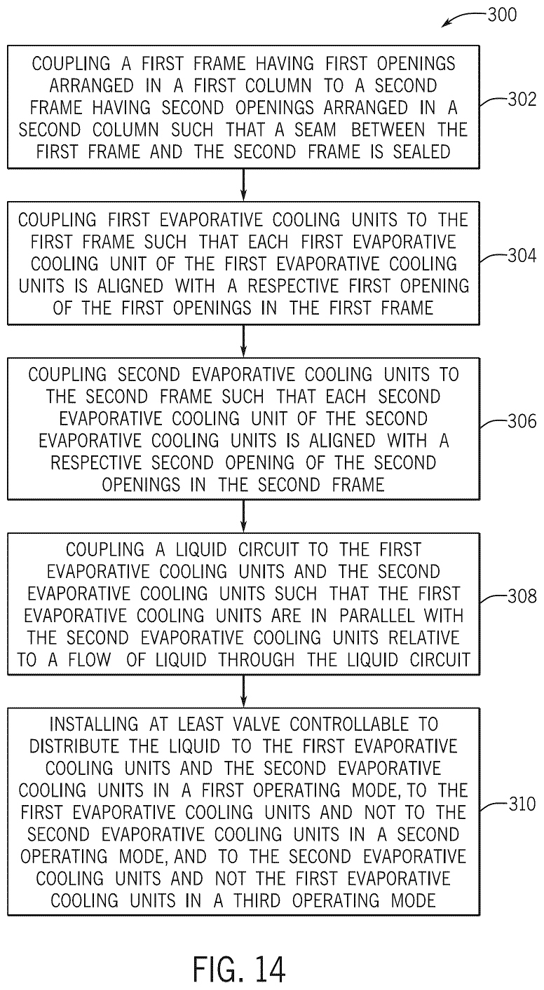

FIG. 14 is a process flow diagram illustrating an embodiment of a method 300 of installing evaporative cooling units in an evaporative cooling system. It should be noted that an order or chronology of the blocks (e.g., steps) of the method 300 illustrated in FIG. 14 and described in detail below should not be taken as necessarily implying an order or chronology of the method 300. Indeed, while the method 300 may be performed in the order or chronology of the blocks (e.g., steps) of the method 300 illustrated in FIG. 14 and described in detail below, other orders or chronologies are also possible. Further, certain of the blocks (e.g., steps) of the method 300 illustrated in FIG. 14 and described in detail below may be optional in certain embodiments. Further still, certain additional blocks (e.g., additional steps) not illustrated in FIG. 14 and/or not described in detail below may be included in certain embodiments of the method 300.

In the illustrated embodiment, the method 300 includes coupling (block 302) a first frame having first openings arranged in a first column to a second frame having second openings arranged in a second column such that a seam between the first frame and the second frame is sealed. For example, as previously described, the first frame may include a first edge (e.g., first flange) and the second frame may include a second edge (e.g., second flange), where the first edge and the second edge are coupled (e.g., via fasteners) to form the sealed seam between the first frame and the second frame. In this way, the airflow (or at least a substantial portion of the airflow) is blocked from passing between the first frame and the second frame, thereby reducing parasitic loss relative to traditional configurations.

The method 300 also includes coupling (block 304) first evaporative cooling units to the first frame such that each first evaporative cooling unit of the first evaporative cooling units is aligned with a respective first opening of the first openings in the first frame. The method 300 also includes coupling (block 306) second evaporative cooling units to the second frame such that each second evaporative cooling unit of the second evaporative cooling units is aligned with a respective second opening of the second openings in the second frame. As previously described, first open ends of the first evaporative cooling units may be aligned with the first openings in the first frame, and second open ends of the second evaporative cooling units may be aligned with the second openings in the second frame. The first evaporative cooling units may be coupled to the first frame via first fasteners, and the second evaporative cooling units may be coupled to the second frame via second fasteners. The first fasteners and the second fasteners may include, for example, blind threaded studs and collapsible bodies.

The method 300 also includes coupling (block 308) a liquid circuit to the first evaporative cooling units and the second evaporative cooling units such that the first evaporative cooling units are in parallel with the second evaporative cooling units relative to a flow of the liquid through the liquid circuit. That is, in certain operating modes, the first evaporative cooling units and the second evaporative cooling units are disposed in parallel with respect to each other. Further, individual first evaporative cooling units corresponding to the first frame or column receive the liquid in parallel with one another.

The method 300 also includes installing (block 310) at least one valve (e.g., at least one on/off valve), such as one on/off valve per column or frame, controllable to distribute the liquid to the first evaporative cooling units and the second evaporative cooling units in a first operating mode, to the first evaporative cooling units and not the second evaporative cooling units in a second operating mode, and to the second evaporative cooling units and not the first evaporative cooling units in a third operating mode. In some embodiments, a controller controls the at least one valve based on a manual input and/or based on feedback (e.g., sensor feedback) indicative of an ambient or operating condition.

In general, presently disclosed systems and methods are configured to improve evaporative cooling effectiveness and efficiency (e.g., by reducing parasitic loss), improve structural integrity of evaporative cooling systems, reduce a cost of installing and/or operating evaporative cooling systems, improve installation time and reduce labor costs associated with evaporative cooling systems, and the like.

While only certain features of present embodiments have been illustrated and described herein, many modifications and changes will occur to those skilled in the art. It is, therefore, to be understood that the appended claims are intended to cover all such modifications and changes that fall within the true spirit of the disclosure. Further, it should be understood that certain elements of the disclosed embodiments may be combined or exchanged with one another.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An evaporative cooling system, comprising:
a frame comprising a plurality of openings arranged in a column; and
a plurality of evaporative cooling units coupled to the frame, wherein each evaporative cooling unit of the plurality of evaporative cooling units comprises:
an open end configured to receive an airflow and aligned with a respective opening of the plurality of openings in the frame;
a closed end opposing the open end and configured to block the airflow; and
a body extending between the open end and the closed end, wherein the body is formed at least in part by a sheet containing a plurality of microporous hollow fibers, wherein each microporous hollow fiber of the plurality of microporous hollow fibers is configured to receive a flow of a liquid establishing a heat exchange relationship between the liquid and the airflow, and wherein the sheet is configured to permit passage of the airflow between an interior defined by the body and an external space.

2. The evaporative cooling system of claim 1, comprising:
an additional frame comprising an additional plurality of openings arranged in an additional column, wherein the additional frame is coupled to the frame such that a seam between the frame and the additional frame is sealed; and
an additional plurality of evaporative cooling units coupled to the additional frame, wherein each additional evaporative cooling unit of the additional plurality of evaporative cooling units comprises:
an additional open end configured to receive the airflow and aligned with a respective additional opening of the additional plurality of openings in the additional frame;
an additional closed end opposing the additional open end and configured to block the airflow; and
an additional body extending between the additional open end and the additional closed end, wherein the additional body is formed by an additional sheet containing an additional plurality of microporous hollow fibers, wherein each additional microporous hollow fiber of the additional plurality of microporous hollow fibers is configured to receive an additional flow of the liquid establishing an additional heat exchange relationship between the liquid and the airflow, and wherein the additional sheet is configured to permit passage of the airflow between an additional interior defined by the additional body and the external space.

3. The evaporative cooling system of claim 2, comprising:
at least one valve; and
a controller configured to control the at least one valve to:
cause the flow of the liquid and block the additional flow of the liquid during a first common time interval in a first operating mode;
block the flow of the liquid and cause the additional flow of the liquid during a second common time interval in a second operating mode; and
cause the flow of the liquid and the additional flow of the liquid during a third common time interval in a third operating mode.

4. The evaporative cooling system of claim 3, wherein the controller is configured to:
receive an input indicative of an ambient or operating condition; and
select between the first operating mode, the second operating mode, and the third operating mode based on the input.

5. The evaporative cooling system of claim 2, comprising a plumbing assembly configured to distribute, in at least one operating mode, the flow of the liquid and the additional flow of the liquid such that the plurality of evaporative cooling units is in parallel with the additional plurality of evaporative cooling units.

6. The evaporative cooling system of claim 1, comprising a fan configured to bias the airflow through the open end, into the interior defined by the body, through the sheet, and into the external space.

7. The evaporative cooling system of claim 1, comprising a fan configured to bias the airflow from the external space, through the sheet, into the interior defined by the body, and through the open end.

8. The evaporative cooling system of claim 1, comprising a bypass damper adjacent to the frame and configured to be:
opened to cause the airflow to bypass the plurality of evaporative cooling units; and
closed to enable the airflow to pass through the plurality of evaporative cooling units.

9. The evaporative cooling system of claim 1, wherein each microporous hollow fiber of the plurality of microporous hollow fibers is configured to permit a vapor generated from the heat exchange relationship to pass to the airflow.

10. An evaporative cooling system, comprising:
a plurality of frames defining a plurality of openings, wherein adjacent frames of the plurality of frames are coupled together to form a sealed seam therebetween;
a plurality of evaporative cooling units coupled to the plurality of frames, aligned with the plurality of openings defined by the plurality of frames, and configured to establish a heat exchange relationship between a liquid and an airflow;
at least one valve; and
a controller configured to control the at least one valve to:
cause the plurality of evaporative cooling units to receive the liquid in a first operating mode; and
cause only a subset of the plurality of evaporative cooling units to receive the liquid in a second operating mode.

11. The evaporative cooling system of claim 10, wherein the plurality of frames comprises:
a first frame defining a first subset of the plurality of openings, wherein the first subset of the plurality of openings is arranged in a first column; and
a second frame defining a second subset of the plurality of openings, wherein the second subset of the plurality of openings is arranged in a second column.

12. The evaporative cooling system of claim 10, wherein each evaporative cooling unit of the plurality of evaporative cooling units comprises:
an open end configured to permit the airflow to pass therethrough;
a closed end opposing the open end and configured to block the airflow from passing therethrough; and
a body extending from the open end to the closed end, wherein the body is defined by a sheet permeable to the airflow and containing a plurality of microporous hollow fibers configured to receive and contain the liquid therein.

13. The evaporative cooling system of claim 12, comprising a fan configured to bias the airflow through the open end, into an interior defined by the body, through the sheet, and into an external space.

14. The evaporative cooling system of claim 12, comprising a fan configured to bias the airflow from an external space, through the sheet, into an interior defined by the body, and through the open end.

15. The evaporative cooling system of claim 10, wherein the controller is configured to:
receive an input indicative of an ambient or operating condition; and
select between the first operating mode and the second operating mode based on the input.

16. The evaporative cooling system of claim 10, wherein the plurality of frames and the plurality of evaporative cooling units form an evaporative cooling assembly, and wherein the evaporative cooling system comprises:
a first bypass damper disposed on a first side of the evaporative cooling assembly, wherein the controller is configured to selectively control the first bypass damper between a first open position and a first closed position; and
a second bypass damper disposed on a second side of the evaporative cooling assembly opposing the first side, wherein the controller is configured to selectively control the second bypass damper between a second open position and a second closed position.

17. A method of installing a plurality of evaporative cooling units in an evaporative cooling system, comprising:
coupling a first frame comprising a first plurality of openings arranged in a first column to a second frame comprising a second plurality of openings arranged in a second column such that a seam between edges of the first frame and the second frame is sealed;
coupling a first plurality of evaporative cooling units to the first frame such that each first evaporative cooling unit of the first plurality of evaporative cooling units is aligned with a respective first opening of the first plurality of openings in the first frame; and
coupling a second plurality of evaporative cooling units to the second frame such that each second evaporative cooling unit of the second plurality of evaporative cooling units is aligned with a respective second opening of the second plurality of openings in the second frame.

18. The method of claim 17, comprising coupling a liquid circuit to the first plurality of evaporative cooling units and the second plurality of evaporative cooling units such that the first plurality of evaporative cooling units is in parallel with the second plurality of evaporative cooling units relative to a flow of liquid through the liquid circuit.

19. The method of claim 18, comprising installing, in the liquid circuit, at least one valve configured to be controlled between:
a first setting in which the first plurality of evaporative cooling units receives the liquid and the second plurality of evaporative cooling units does not receive the liquid during a first common time interval;
a second setting in which the second plurality of evaporative cooling units receives the liquid and the first plurality of evaporative cooling units does not receive the liquid during a second common time interval; and
a third operating mode in which the first plurality of evaporative cooling units and the second plurality of evaporative cooling units receives the liquid during a third common time interval.

20. The method of claim 17, comprising:
coupling the first plurality of evaporative cooling units to the first frame via a first plurality of fasteners, wherein the first plurality of fasteners comprises a first plurality of threaded studs configured to be received by a first plurality of holes in the first frame, and the first plurality of fasteners comprises a first plurality of bodies coupled to the first plurality of evaporative cooling units and configured to receive the first plurality of threaded studs; and
coupling the second plurality of evaporative cooling units to the second frame via a second plurality of fasteners, wherein the second plurality of fasteners comprises a second plurality of threaded studs configured to be received by a second plurality of holes in the second frame, and the second plurality of fasteners comprises a second plurality of bodies coupled to the second plurality of evaporative cooling units and configured to receive the second plurality of threaded studs.
